(19) United States
(12) Patent Application Publication
(10) Pub. No.: US 2011/0159257 A1
(43) Pub. Date: Jun. 30, 2011

(54) CELLULOSE ESTER FILM AND METHOD FOR PRODUCING THE SAME

(76) Inventors: Han-Sung Kim, Seongnam-si (KR); Yong-Won Kim, Seoul (KR); Yu-Jin Choi, Hwaseong-si (KR); Jik-Soo Shin, Seoul (KR)

(21) Appl. No.: 12/768,311

(22) Filed: Apr. 27, 2010

(30) Foreign Application Priority Data
Dec. 31, 2009 (KR) 10-2009-0135500

(51) Int. Cl. F21V 9/06; B32B 7/02; B32B 23/00; B29C 47/00

(52) U.S. Cl. 428/213; 252/589; 428/220; 264/211.12

(57) ABSTRACT

A cellulose ester film for protecting a polarizing plate of a Liquid Crystal Display device, and a method for producing the same are disclosed. The cellulose ester film comprises a benzotriazole-based UV absorbent of Formula 1 and a triazine-based UV absorbent of Formula 2,

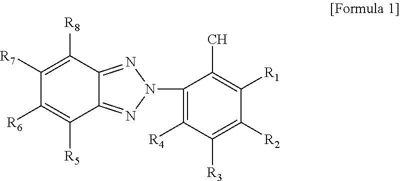

wherein, in Formula 1, R₁, R₂, R₃, R₄, R₅, R₆, R₇ and R₈ represent independently hydrogen atom, halogen atom, hydroxy group, alkyl group, alkenyl group, alkoxy group, alkylthio group, aryl group, aryloxy group or arylthio group,

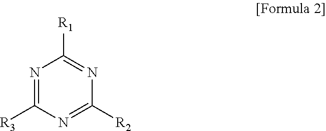

wherein, in Formula 2, R R₁, R₂ and R₃ represent independently alkyl group, alkenyl group, alkoxy group, alkylthio group, aryl group, aryloxy group or arylthio group.

This application claims the priority benefit of Korean Patent Application No. 10-2009-0135500 filed on Dec. 31, 2009. All disclosure of the Korean Patent application is incorporated herein by reference.

### FIELD OF THE INVENTION

This invention relates to a cellulose ester film and a method for producing the same, and more particularly to a cellulose ester film for protecting a polarizing plate of a Liquid Crystal Display(LCD) device, and a method for producing the same.

### BACKGROUNDS OF THE INVENTION

Recently, as the demand for portable devices or televisions having a LCD increases, the studies for improving the image quality of the LCD and for reducing a production cost have been actively carried out. The LCD is one of the representative flat panel displays that are commercially available. In LCD, the light emitted from a back-light passes through liquid crystal molecules having an anisotropic property and polarizing plates to produce an image. The LCD can be classified into a TN (Twisted nematic)-mode LCD, a VA (Vertical Alignment)-mode LCD and an IPS (In-Plane Switching)-mode LCD. In TN-mode LCD, liquid crystal molecules having a positive (+) dielectric anisotropy are arranged in parallel between a pair of substrates facing each other. In VA-mode LCD, liquid crystal molecules having a negative (−) dielectric anisotropy are arranged in vertical between a pair of substrates facing each other.

In LCD, a cellulose ester film, such as a triacetyl cellulose film, is attached on a polarizing plate for protecting the polarizing plate. The cellulose ester film has desirable optical properties, such as a good transparency, a low refraction-index anisotropy, and so on, and therefore is widely used as an optical film, such as a protection film for a polarizing plate. The cellulose ester film may be degraded when exposed to ultraviolet (UV) rays for a long time. Thus, a UV absorbent is generally added to the cellulose ester film for blocking the UV rays. As the UV absorbent for the cellulose ester film, a conventional UV absorbent, for example, benzophenone compounds or benzotriazole compounds, is used. If such a conventional UV absorbent is used for a long time at high temperature and high humidity, the UV absorbency of the film is reduced and the color of the film changes to yellow. Also, the UV absorbent in the cellulose ester film is bled out during a drying process of a cellulose film at high temperature, which contaminates the cellulose ester film. The UV absorbent is also eluted out in an alkali saponification process for producing a polarizing plate, which contaminates the equipments for producing the polarizing plate.

### SUMMARY OF THE INVENTION

Therefore, it is an object of the present invention to provide a cellulose ester film having a good UV absorbency and a desirable durability. It is other object of the present invention to provide a cellulose ester film capable of reducing a bleed-out and an elution of UV absorbent. It is another object of the present invention to provide a cellulose ester film which improves a productivity of a polarizing plate and a method for producing the same.

In order to achieve these objects, the present invention provides a cellulose ester film comprising a benzotriazole-based UV absorbent of the following Formula 1 and a triazine-based UV absorbent of the following Formula 2,

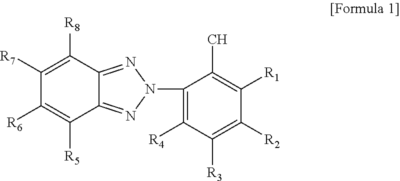

wherein, in Formula 1, R₁, R₂, R₃, R₄, R₅, R₆, R₇ and R₈ represent independently hydrogen atom, halogen atom, hydroxy group, alkyl group, alkenyl group, alkoxy group, alkylthio group, aryl group, aryloxy group or arylthio group,

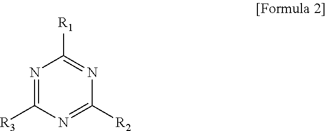

in Formula 2, R₁, R₂ and R₃ represent independently alkyl group, alkenyl group, alkoxy group, alkylthio group, aryl group, aryloxy group or arylthio group.

The present invention also provides a method for producing a cellulose ester film, comprising the steps of i) extruding a casting solution on a belt to form a sheet, wherein the casting solution includes a cellulose ester resin, a solvent for dissolving the cellulose ester resin, a benzotriazol-based UV absorbent of the Formula 1 and a triazine-based UV absorbent of the Formula 2; ii) evaporating solvent in the casting solution to form a cellulose ester film; iv) peeling off the cellulose ester film from the belt, and iii) stretching and drying the cellulose ester film.

The cellulose ester film according to the present invention has a good UV absorbency and a desirable durability, and minimizes the bleed-out or the elution of the UV absorbent so that the productivity of a polarizing plate is enhanced.

### BRIEF DESCRIPTION OF THE DRAWINGS

FIG. 1 is a cross-sectional view of a cellulose ester film having a three-layer-structure according to an embodiment of the present invention.

FIG. 2 shows an overall apparatus for producing a cellulose ester film of the present invention.

FIG. 3 is a cross-sectional view of a die and a belt of the apparatus shown in FIG. 2.

### DETAILED DESCRIPTION OF THE INVENTION

A more complete appreciation of the invention, and many of the attendant advantages thereof, will be better appreciated by reference to the following detailed description.

The cellulose ester film according to the present invention may have a single layer structure and comprises a plasticizer for providing pliability to the cellulose ester film, a benzotriazole-based UV absorbent of the following Formula 1 and a triazine-based UV absorbent of the following Formula 2.

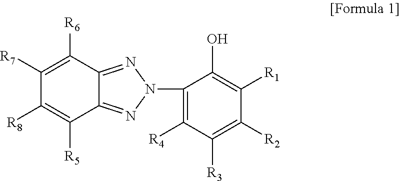

In Formula 1, R₁, R₂, R₃, R₄, R₅, R₆, R₇ and R₈ represent independently hydrogen atom, halogen atom, hydroxy group, alkyl group, alkenyl group, alkoxy group, alkylthio group, aryl group, aryloxy group or arylthio group.

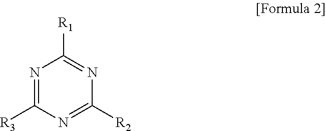

In Formula 2, R₁, R₂ and R₃ represent independently alkyl group, alkenyl group, alkoxy group, alkylthio group, aryl group, aryloxy group or arylthio group.

In Formula 1 and Formula 2, carbon number of alkyl group, alkenyl group, alkoxy group, or alkylthio group is preferably 1 to 36, and more preferably 5 to 18, and carbon number of aryl group, aryloxy group or arylthio group is preferably 5 to 40, and more preferably 6 to 24. The total amount of the two UV absorbents of Formula 1 and Formula 2 is 0.5 to 3.0 weight %, and preferably 1 to 2 weight % with respect to the total cellulose ester film. If the total amount of the UV absorbents is below the range, the UV absorbency may be undesirable. If the total amount of the UV absorbents is above the range, the bleed-out of the UV absorbent and the yellowing of the cellulose ester film may occur. Specifically, the amount of the benzotriazole-based UV absorbent of Formula 1 is 0.2 to 1.5 weight %, preferably 0.3 to 1.2 weight %, and more preferably 0.5 to 1.0 weight % with respect to the total cellulose ester film. The amount of the triazine-based UV absorbent of Formula 2 is 0.3 to 1.5 weight %, preferably 0.7 to 1.2 weight %, and more preferably 0.8 to 1.0 weight % with respect to the total cellulose ester film. If the amount of the benzotriazole-based UV absorbent is below the range, the UV absorbency at 380 nm or less may be undesirable, and if the amount of the benzotriazole-based UV absorbent is above the range, b value of a film color may increase. If the amount of the triazine-based UV absorbent is below the range, the UV absorbency at high temperature may be undesirable, and if the amount of the benzotriazole-based UV absorbent is above the range, it is economically undesirable and the production cost may increase.

The plasticizer used in the cellulose ester film of the present invention is for imparting pliability to the cellulose ester film and the amount thereof is 10 to 30 weight part with respect to 100 weight part of the cellulose ester resin. Examples of the plasticizer include a phosphoric ester plasticizer such as triphenyl phosphate (TPP) and biphenyl diphenylphosphate (BDP), a phthalic ester plasticizer such as diethyl phthalate and dimethoxy ethyl phthalate, a glycolic ester plasticizer such as ethyl phthalyl ethyl glycolate (EPEG) and butyl phthalyl butyl glycolate (BPBG), and so on.

The cellulose ester resin is a conventional component, and example of the cellulose ester resin includes cellulose acetate such as triacetyl cellulose (TAC), cellulose acetate propionate (CAP), and so on. The average acetylation degree of the cellulose ester resin can be 58.0 to 62.0%, and preferably 58.5 to 61.5%. If the acetylation degree is too low, the optical isotropy of the film may be undesirable, and if the acetylation degree is too high, the cellulose ester resin may not be completely dissolved and defects can be formed on the film.

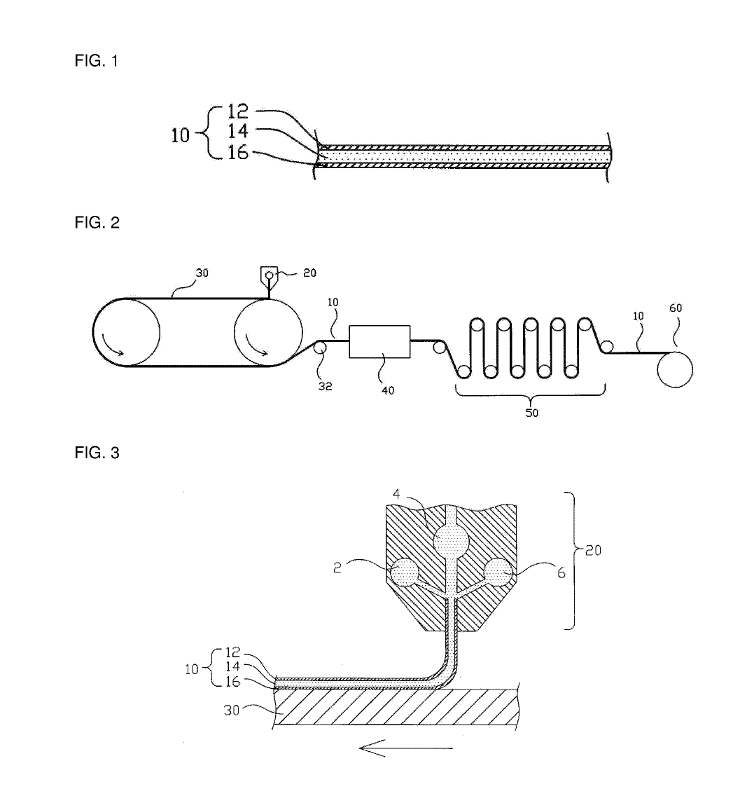

FIG. 1 is a cross-sectional view of a cellulose ester film having a three-layer-structure according to other embodiment of the present invention. As shown in FIG. 1, the cellulose ester film 10 may have a multi-layer-structure including a front layer 12, an inner layer 14 and a rear layer 16. The thickness of the front layer 12 and/or the rear layer 16 is independently 5 to 20%, and preferably 10 to 15% with respect to the total thickness of the cellulose ester film 10. Preferably, both of the benzotriazole-based UV absorbent and the triazine-based UV absorbent are contained in the inner layer 14. If the thickness of the front layer 12 or the rear layer 16 is too thin, the bleed-out of the UV absorbents cannot be sufficiently prevented, and if the thickness of the front layer 12 or the rear layer 16 is too thick, the amount of the UV absorbents in the film 10 is too little and the absorbency of UV rays may be undesirable.

Referring to FIGS. 2 and 3, a method for producing a cellulose ester film of the present invention will be explained. FIG. 2 shows an overall apparatus for producing a cellulose ester film of the present invention, and FIG. 3 show a cross-sectional view of a die and a belt of the apparatus shown in FIG. 2. In order to produce the cellulose ester film 10 of the present invention, firstly, casting solutions 2, 4, 6 are co-extruded through a die 20 on a belt 30 to form a sheet. Then, the solvent in the casting solutions 2, 4, 6 is evaporated to form the cellulose ester film 10. As the die 20, a conventional T-die can be used. The belt 30 is a high-temperature supporter for forming the cellulose ester film 10 with conveying and drying the casting solutions 2, 4, 6. As the belt 30, stainless steel conveyor belt can be used.

In case of forming a cellulose ester film having a single-layer-structure, only one casting solution, for example the second casting solution 4 is extruded, and the casting solution comprises the cellulose ester resin, the solvent for dissolving the cellulose ester resin, the plasticizer for imparting a pliability to the cellulose ester film, the benzotriazole-based UV absorbent, and the triazine-based UV absorbent. In case of forming a cellulose ester film having a three-layer-structure as shown in FIG. 3, the first casting solution 2, the second casting solution 4 and the third casting solution 6 are simultaneously extruded. The first and third casting solutions 2, 6 contain the cellulose ester resin, the solvent for dissolving the cellulose ester resin and the plasticizer for imparting a pliability to the cellulose ester film without the UV absorbent. Meanwhile, the second casting solution 4 contains the above-mentioned benzotriazole-based UV absorbent and triazine-based UV absorbent in addition to the cellulose ester resin, the solvent and the plasticizer. The first casting solution 2 forms the front layer 12, the second casting solution 4 forms the inner layer 14, and the third casting solution 6 forms the rear layer 16. The casting solutions 2, 4, 6 are conventionally called as ‘dope’. The amount of the cellulose ester resin in the dope is 10 to 25 weight %, and preferably 15 to 20 weight %. The solvent may be an organic solvent, and the examples of the solvent include methylene chloride (MC), methyl acetic acid, alcohol (for example, methanol), and so on. The cellulose ester resins and/or the solvents in the first casting solution 2, the second casting solution 4 and the third casting solution 6 may be same or different.

Referring to FIG. 2, the casting solution 2, 4, 6 coated on the belt 30 travels with the belt 30 for a predetermined time and distance that are enough to form the cellulose ester film 10, and then the cellulose ester film 10 is peeled off from the belt 30 by a peel-off roller 32 which is a guide roller. The peeled film 10 is conveyed to a tenter 40, is stretched in a transverse direction (TD) and/or a mechanical direction (MD) and then is dried at a drier 50, to form a final cellulose ester film 10. The final cellulose ester film 10 is wound by a winder 60 to be commercial products.

The thickness of the cellulose ester film 10 (the thickness after the stretching and drying step) is generally 20 to 80 μm. However, the thickness can be changed at need. A retardation in the direction of film thickness (Rth, λ=550 nm) of the cellulose ester film 10 is generally 20 to 100 nm. The retardation in the direction of film thickness (Rth) means a retardation in the vertical direction of a film at a given wavelength. When a refractive index along the slow axis in the film plane is nx, a refractive index along the fast axis in the film plane is ny, a refractive index in the thickness direction of the film is nz, and the thickness of the film is d(nm), the retardation in the direction of film thickness (Rth) is defined as (Rth)=((nx+ny)/2−nz)*d. The cellulose film 10 of the present invention is typically attached to one side or both sides of a polarizing plate of polyvinyl alcohol (PVA) to protect the polarizing plate. The polarizing plate having the cellulose film 10 is mounted on an upper substrate and/or a lower substrate of a LCD panel. If necessary, the cellulose film 10 may be positioned on the polarizing plate with a predetermined gap.

Hereinafter, the preferable examples and comparative example are provided for better understanding of the present invention. However, the present invention is not limited by the following examples.

### Example 1

### Production of Cellulose Film of Single-Layer-Structure

A casting solution was prepared with 100 weight part of triacetyl cellulose (TAC), 15 weight part of triphenyl phosphate, 658 weight part of methylene chloride(MC), 100 weight part of ethanol, 0.39 weight part of 2-(2′-hydroxy-5′-methylphenyl)benzotriazole and 0.39 weight part of 2-(2′-hydroxy-3,5′-di-t-butylphenyl)-5-chloro benzotriazole as the benzotriazole-based UV absorbent and 0.39 weight part of trisaryl-1,3,5-triazine as the triazine-based UV absorbent. By using the die 20 shown in FIG. 2, the casting solution was extruded into a metal belt 30 to form a sheet having the width of 600 mm. The solvent in the casting solution was evaporated while the metal belt 30 was moved, and the 10% stretching and drying process were carried out to produce the cellulose ester film 10 having a thickness of 80 μm. After placing the cellulose ester film at 70° C., 90% of relative humidity (RH) for 500 hours, the optical properties of the film were measured and the results are shown in the following Table 1. As shown in Table 1, the cellulose ester film of the present invention has desirable optical properties of a low transmittance change at 380 nm and less color change.

### Example 2

### Production of Cellulose Film of Three-Layer-Structure

The first casting solution 2 for forming the front layer 12 and the third casting solution 6 for forming the rear layer 16 were prepared with 100 weight part of TAC, 15 weight part of triphenyl phosphate, 658 weight part of MC and 100 weight part of ethanol, and the second casting solution 4 for forming the inner layer 14 was prepared with 100 weight part of TAC, 15 weight part of triphenyl phosphate, 658 weight part of MC, 100 weight part of ethanol, 0.39 weight part of 2-(2′-hydroxy-5′-methylphenyl)benzotriazole and 0.39 weight part of 2-(hydroxy-5-t-octylphenyl)benzotriazole as the benzotriazole-based UV absorbents and 0.39 weight part of trisaryl-1,3,5-triazine as the triazine-based UV absorbent. By using the die 20 shown in FIG. 3 the first casting solution 2, the second casting solution 4 and the third casting solution 6 were simultaneously extruded into the metal belt 30 to form of a sheet having the width of 600 mm. The solvent in the casting solution was evaporated while the metal belt 30 was moved, and the 10% stretching and drying process were carried out to produce the cellulose ester film 10 having the total thickness of 80 μm, in which the thickness of the front layer 12, the thickness of the rear layer 16, and the thickness of the inner layer 14 are respectively 12 μm, 12 μm, and 56 μm. After placing the cellulose ester film at 70° C., 90% of relative humidity (RH) for 500 hours, the optical properties of the film were measured and the results are shown in the following Table 1.

TABLE 1

| | | | | Change of | |
|---|---|---|---|---|---|
| | | Color | Color | amount | |
| | Change of | Change | Change | of UV | Retar- |
| | Transmittance | (%) | (%) | absorbent | dation |
| | (%) | (a value) | (b value) | (%) | (Rth) |
| Example 1 | 2 | 1.5 | 1.7 | 1.7 | 70 |
| Example 2 | 1.8 | 1.6 | 1.8 | 0.9 | 65 |

As shown in Table 1, the cellulose ester film of the present invention has good optical properties such as a low transmittance change at 380 nm and a less color change. In addition, by evaluating the amount of the UV absorbent in the cellulose ester film 10 with a gas chromatography (GC) after 500 hours, it is revealed that the amount of the UV absorbent which was bled out from the cellulose ester film 10 is less than 2 weight %.

### Examples 3 and 4, Comparative Example

### Production And Evaluation of Cellulose Film

Except for using the non-phosphoric acid ester type plasticizer (aliphatic polyhydric alcohol ester), the phosphoric acid ester type plasticizer, the benzotriazole-based or the triazine-based UV absorbent and the fine particles in the front layer 12, the inner layer 14 and the rear layer 16 with the amounts shown in Table 2, the cellulose film 10 was produced according to the method of Example 2. In Table 1, the amount of each component represents an amount with respect to the weight (wt) of each layer 12, 14 or 16.

TABLE 2

| | Comparative Example | Example 3 | Example 4 |
|---|---|---|---|
| Front | 10 wt % of phosphoric acid | 5 wt % of non-phosphoric | 7 wt % of non-phosphoric |
| Layer | ester plasticizer, 2 wt % of | acid ester plasticizer, and | acid ester plasticizer, and 1 wt |
| 12 | non-phosphoric acid ester | 1.3 wt % of fine particles | % of fine particles |
| | plasticizer, 1 wt % of fine | | |
| | particles, and 0.5 wt % of | | |
| | benzotriazole UV absorbent | | |
| Inner | 12 wt % of phosphoric acid | 10 wt % of phosphoric acid | 10 wt % of phosphoric acid |
| Layer | ester type plasticizer, and | ester plasticizer, 0.5 wt % of | ester plasticizer, 0.5 wt % of |
| 14 | 0.5 wt % of UV absorbent | benzotriazole UV absorbent, | benzotriazole UV absorbent, |
| | | and 0.5 wt % of triazine UV | and 0.5 wt % of triazine UV |
| | | absorbent | absorbent |
| Rear | 10 wt % of phosphoric acid | 5 wt % of non-phosphoric | 7 wt % of non-phosphoric |
| Layer | ester plasticizer, 2 wt % of | acid ester plasticizer, and | acid ester plasticizer, and 1 wt |
| 16 | non-phosphoric acid ester | 1.3 wt % of fine particles | % of fine particles |
| | plasticizer, 1 wt % of fine | | |
| | particles, 0.5 wt % of | | |
| | benzotriazole UV absorbent | | |

The friction coefficient, haze, elution amount of plasticizer/UV absorbents (determined by measuring FT-IR absorbance), transmittance at 380 nm, and dimensional stability at high humidity of the cellulose film 10 were measured and the results are shown in Table 3. The haze of the cellulose film 10 was measured with a hazemeter of Nippon Denshoku Industries Co., Ltd. (Japan), and the dimensional stability was measured with a dial gauge after placing the cellulose film 10 for 30 minutes at 60° C. and 95% humidity.

TABLE 3

| | Comparative Example | Example 3 | Example 4 |
|---|---|---|---|
| Friction coefficient | 0.5 | 0.6 | 0.7 |
| Haze | 0.4 | 0.3 | 0.2 |
| Elution amount of | 60% | 50% | 40% |
| plasticizer/UV absorbents | | | |
| Transmittance at 380 nm | 2% | 3% | 1.5% |
| Dimensional stability at | 0.15% | 0.10% | 0.08% |
| high humidity | | | |

As shown in Table 3, the cellulose film of the present invention has good physical properties, such as the friction coefficient, the haze, the elution amount of plasticizer/UV absorbents, the transmittance at 380 nm and the dimensional stability at high humidity.

1. A cellulose ester film comprising:
a benzotriazole-based UV absorbent of the following Formula 1; and
a triazine-based UV absorbent of the following Formula 2, 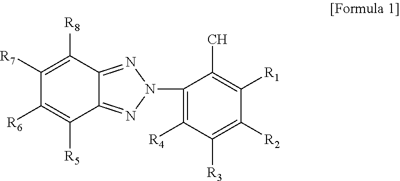
wherein, in Formula 1, R₁, R₂, R₃, R₄, R₅, R₆, R₇ and R₈ represent independently hydrogen atom, halogen atom, hydroxy group, alkyl group, alkenyl group, alkoxy group, alkylthio group, aryl group, aryloxy group or arylthio group, 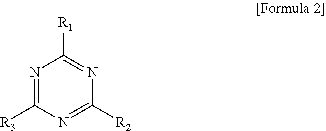
wherein, in Formula 2, R₁, R₂ and R₃ represent independently alkyl group, alkenyl group, alkoxy group, alkylthio group, aryl group, aryloxy group or arylthio group.

2. The cellulose ester film of claim 1, wherein the total amount of the UV absorbents of Formula 1 and Formula 2 is 0.5 to 3.0 weight % with respect to the total cellulose ester film.

3. The cellulose ester film of claim 1, wherein the amount of the benzotriazole-based UV absorbent of Formula 1 is 0.2 to 1.5 weight % with respect to the total cellulose ester film.

4. The cellulose ester film of claim 1, wherein the amount of the triazine-based UV absorbent of Formula 2 is 0.3 to 1.5 weight % with respect to the total cellulose ester film.

5. The cellulose ester film of claim 1, wherein an average acetylation degree of a cellulose ester resin of the cellulose ester film is 58.0 to 62.0%.

6. The cellulose ester film of claim 1, wherein the cellulose ester film includes a front layer, an inner layer and a rear layer, and the thickness of the front layer and/or the rear layer is 5 to 20% with respect to the total thickness of the cellulose ester film.

7. The cellulose ester film of claim 1, wherein the benzotriazole-based UV absorbent and the triazine-based UV absorbent are contained in the inner layer.

8. The cellulose ester film of claim 1, wherein the thickness of the cellulose ester film is 20 to 80 μm, and a retardation in the direction of film thickness (Rth, λ=550 nm) of the cellulose ester film is 20 to 100 nm.

9. A method for producing a cellulose ester film, comprising the steps of:
i) extruding a casting solution on a belt to form a sheet, wherein the casting solution includes a cellulose ester resin, a solvent for dissolving the cellulose ester resin, a benzotriazol-based UV absorbent of the Formula 1 and a triazine-based UV absorbent of the Formula 2;
ii) evaporating solvent in the casting solution to form a cellulose ester film;
iii) peeling off the cellulose ester film from the belt, and
iv) stretching and drying the cellulose ester film, 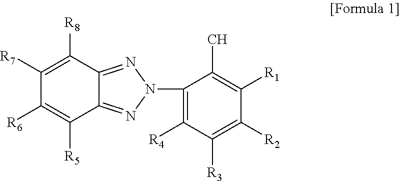
wherein, in Formula 1, R₁, R₂, R₃, R₄, R₅, R₆, R₇ and R₈ represent independently hydrogen atom, halogen atom, hydroxy group, alkyl group, alkenyl group, alkoxy group, alkylthio group, aryl group, aryloxy group or arylthio group, 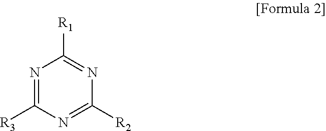
wherein, in Formula 2, R₁, R₂ and R₃ represent independently alkyl group, alkenyl group, alkoxy group, alkylthio group, aryl group, aryloxy group or arylthio group.
